(19) United States
(12) Patent Application Publication
(10) Pub. No.: US 2021/0336371 A1
(43) Pub. Date: Oct. 28, 2021

(54) CONNECTOR

(71) Applicant: Yazaki Corporation, Tokyo (JP)

(72) Inventors: Masaki IMAMURA, Makinohara-shi (JP); Hiroshi Miyazaki, Fujieda-shi (JP)

(73) Assignee: Yazaki Corporation, Tokyo (JP)

(21) Appl. No.: 17/230,185

(22) Filed: Apr. 14, 2021

(30) Foreign Application Priority Data
Apr. 24, 2020 (JP) 2020-077518

(51) Int. Cl. H01R 13/506

(52) U.S. Cl. CPC H01R 13/506

(57) ABSTRACT

A connector includes a housing and a plate-shaped lever which is pivotably supported by the housing, wherein the housing includes a pair of wall sections opposed in a rotation axis direction of the lever, wherein one of the pair of wall sections includes a rotation shaft section protruding towards another of the pair of wall sections, wherein the rotation shaft section is provided in a flexible arm which is cut out from the one wall section, and wherein it is configured so that in a natural state of the flexible arm, the lever is pivotably supported by the rotation shaft section, wherein when the lever which is not mounted is inserted between the pair of wall sections and comes into contact with the rotation shaft section, the flexible arm is bent in a direction away from the another wall section with interposition of the one wall section.

### BACKGROUND OF THE INVENTION

### Technical Field

The present invention relates to a connector.

### Background Art

Conventionally, a lever-based connector is proposed which includes a housing and a plate-shaped lever pivotably mounted in the housing (see e.g. Patent Document 1). The lever-based connector according to Patent Document 1 is configured so that the lever is rotated in order to bring the housing and a partner housing close to each other and to mate them while the lever is pivotably supported by the housing.

The housing has a lever accommodating space which accommodates the lever therein. The lever accommodating space has an upper wall and a lower wall, wherein the upper wall forms a shell wall of the housing, and the lower wall is opposed to the upper wall, wherein the lever accommodating space extends through the housing in a mating direction of the housing and the partner housing. The upper wall has a hole section into which a cylindrical shaft section in the lever is inserted. When the lever is supported by the housing, the lever is inserted into the lever accommodating space, wherein the shaft section of the lever is inserted through the hole section in the upper wall. In this manner, the lever is supported by (pivotably mounted in) the housing in a freely rotatable manner.

### CITATION LIST

### Patent Literature

Patent Document 1: JP 2015-79657 A

### SUMMARY OF THE INVENTION

However, when inserting the lever into the lever accommodating space in the conventional lever-based connector, it is necessary to insert the shaft section of the lever into the hole section in the upper wall by primarily bending the upper wall, which results in a bad operability for assembling.

An objective of the present invention is to provide a connector which may enable the operability for assembling to be improved.

In order to achieve the objective as described above, the invention according to claim 1 relates to a connector including a housing and a plate-shaped lever which is pivotably supported by the housing and rotatable, wherein the housing includes a pair of wall sections opposed to each other in a rotation axis direction of the lever, wherein one wall section of the pair of wall sections includes a rotation shaft section protruding towards another wall section of the pair of wall sections, wherein the rotation shaft section is provided in a flexible arm which is cut out from the one wall section, and wherein it is configured so that in a natural state of the flexible arm, the lever is pivotably supported by the rotation shaft section, wherein when the lever which is not mounted is inserted between the pair of wall sections and comes into contact with the rotation shaft section, the flexible arm is bent in a direction away from the another wall section with interposition of the one wall section.

The invention according to claim 2 relates to the connector according to claim 1, including an inner housing configured to be inserted into the housing, wherein the housing has an insertion space for inserting the inner housing therein, wherein in the natural state of the flexible arm, the inner housing is allowed to be inserted into the housing, and wherein in a bent state of the flexible arm, the flexible arm enters the insertion space so that the inner housing comes into contact with the flexible arm to limit insertion of the inner housing into the housing.

The invention according to claim 1 provides that the housing includes a pair of wall sections opposed to each other in a rotation axis direction of the lever, wherein one wall section of the pair of wall sections includes a rotation shaft section protruding towards another wall section of the pair of wall sections, wherein the rotation shaft section is provided in a flexible arm which is cut out from the one wall section, wherein it is configured so that in the natural state of the flexible arm, the lever is pivotably supported by the rotation shaft section, wherein when the lever which is not mounted is inserted between the pair of wall sections and comes into contact with the rotation shaft section, the flexible arm is bent in a direction away from the another wall section with interposition of the one wall section. With this configuration, when the lever comes into contact with the rotation shaft section, the flexible arm is bent to displace the rotation shaft section in the direction away from the another wall section so that the rotation shaft section is removed outside the pair of wall sections. This enables the lever to be inserted between the pair of wall sections without bending the wall sections. Thus, it is possible to enable the operability for assembling the connector to be improved.

### BRIEF DESCRIPTION OF THE DRAWINGS

FIG. 1 is a front view of a connector according to an embodiment of the present invention;

FIG. 2 is an exploded perspective view of the connector;

FIG. 3 is a front view of a housing as a part of the connector;

FIG. 4 is a transverse sectional view along the line I-I in FIG. 3;

FIG. 5 is a perspective view for explaining a procedure for assembling the connector, illustrating how a lever as a part of the connector is brought close to the housing;

FIG. 6 is a longitudinal sectional view of the connector according to FIG. 5;

FIG. 7 is a longitudinal sectional view of a post process following FIG. 6, illustrating that the lever is pivotably supported by the housing and positioned in an initial position;

FIG. 8 is a longitudinal sectional view illustrating how insertion of an inner housing into the housing is limited; and

FIG. 9 is a longitudinal sectional view illustrating how the inner housing is allowed to be inserted into the housing, and when mating the connector with a partner connector, the lever is rotated to a completely rotated position.

### DETAILED DESCRIPTION OF THE PREFERRED EMBODIMENTS

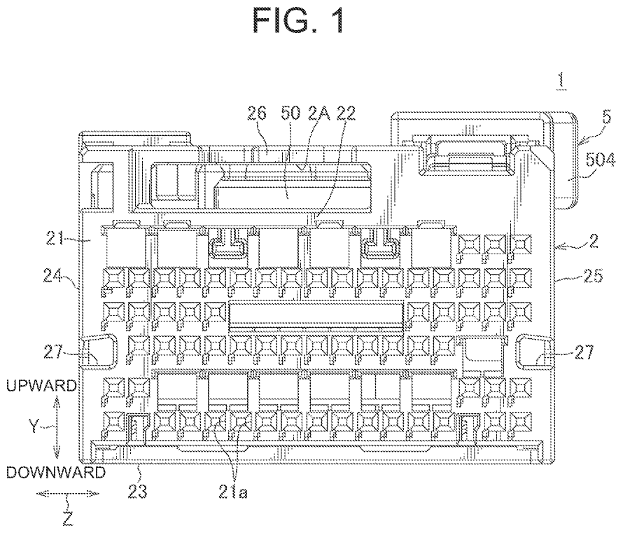

Hereinafter, embodiments of the present invention will be described with reference to FIGS. 1 to 9. FIG. 1 is a front view of a connector according to an embodiment of the present invention.

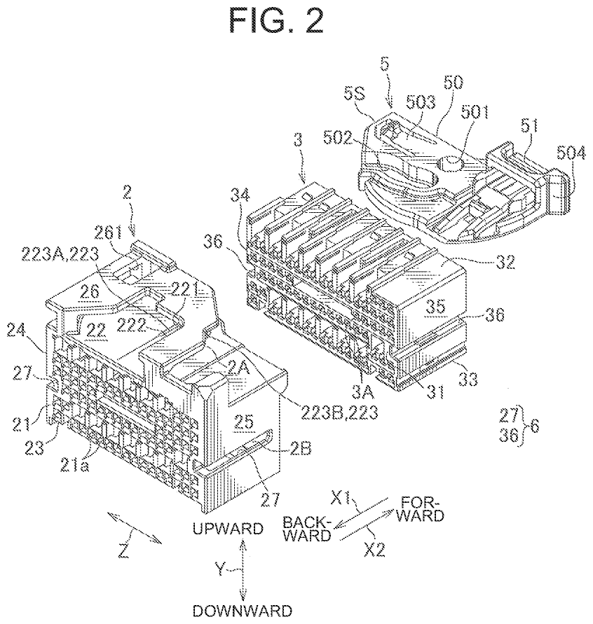

As shown in FIGS. 1, 2 and 9, a connector 1 according to the present embodiment includes an outer housing 2, an inner housing 3 (shown in FIG. 2), a side spacer 4 (shown in FIG. 8), a lever member 5 pivotably supported by the outer housing 2, and terminals (not shown), wherein the outer housing 2 corresponds to a housing according to claims. The terminals of the connector 1 are connected to ends of electric wires (now shown), wherein in a state of the lever member 5 which is pivotably supported by the outer housing 2, the terminals of the connector 1 are mated with terminals of a partner connector (not shown) by rotating the lever member 5.

According to the present embodiment, an inserting direction of the inner housing 3 into the outer housing 2 shall be an X-direction, wherein two directions substantially orthogonal to the X-direction shall be a Y- and Z-direction. A rotation axis direction of the lever member 5 shall be the Y-direction. Further, an X1-direction (inserting direction of the inner housing 3 into the outer housing 2) and an X2-direction may be referred to as “forward” and “backward”, respectively, wherein one direction along the Y-direction may referred to as “upward”, while the other opposite direction along the Y-direction may be referred to as “downward”.

As shown in FIG. 2, the outer housing 2 is formed e.g. from a resin member in a quadrilateral-tubular shape having an extending direction (axial direction of the tube) along the X-direction. This outer housing 2 includes an outer wall section 21 along a ZY-plane, four outer surrounding walls 22, 23, 24 and 25, and an outer shell wall 26, wherein the outer surrounding walls 22, 23, 24 and 25 are continuous with the outer wall section 21, and the outer shell wall 26 is located above and opposed to the outer surrounding wall 22 along the ZX-plane (hereinafter referred to as “outer upper wall 22”). The outer upper wall 22 corresponds to “one wall section” according to claims, and the outer shell wall 26 corresponds to “another wall section” according to claims. The outer wall section 21 has terminal insertion holes 21a allowing tab terminals of a partner connector (not shown) to be inserted therethrough. The terminal insertion holes 21a are provided in positions to be connected to terminal accommodating chambers 3A in the inner housing 3 which will be described below, wherein the terminal insertion holes 21a are configured to allow the tab terminals to enter the terminal accommodating chambers 3A.

As shown in FIG. 2, the outer housing 2 further has a lever mounting space 2A for mounting the lever member 5 therein, and a housing accommodating space 2B for accommodating the inner housing 3, wherein the housing accommodating space 2B corresponds to an insertion space according to claims. The lever mounting space 2A and housing accommodating space 2B are defined by the outer upper wall 22.

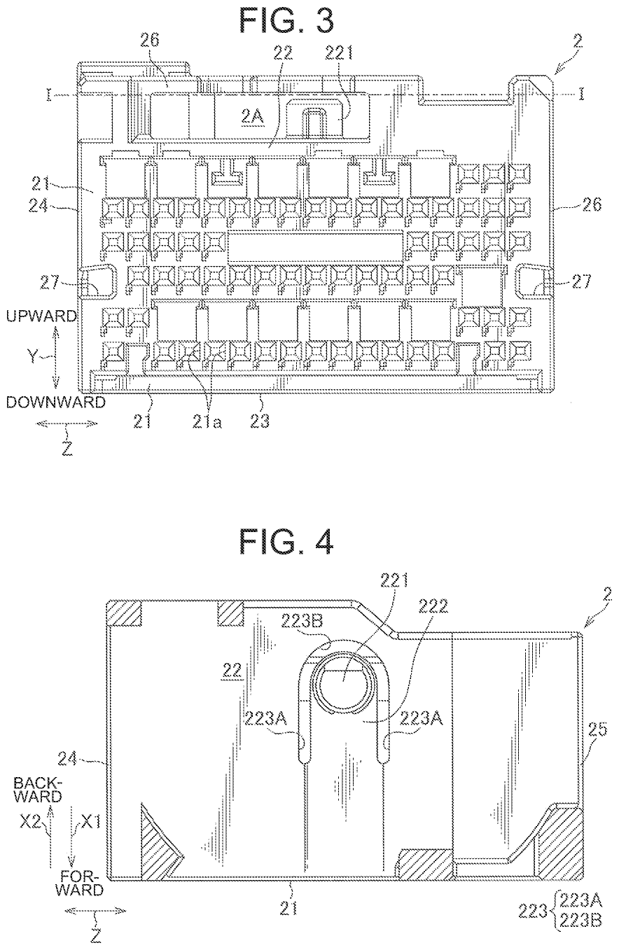

The lever mounting space 2A is provided between the outer upper wall 22 and the outer shell wall 26, as shown in FIGS. 2 and 3. At the lever mounting space 2A, a separation between the outer upper wall 22 and the outer shell wall 26 is formed with a substantially same dimension as a thickness of a lever main body 50 of the lever member 5 as described below.

As shown in FIG. 4, the outer upper wall 22 includes a lever rotating shaft 221 and a flexible arm 222, wherein the lever rotating shaft 221 corresponds to a rotation shaft section according to claims. The lever rotating shaft 221 is provided in a middle portion of the outer upper wall 22 in the Z-direction. The lever rotating shaft 221 is formed in a cylindrical shape and protrudes upward from the outer upper wall 22, wherein the lever rotating shaft 221 allowed to be inserted through a shaft bearing portion 501 of the lever main body 50 and pivotably supports the lever main body 50, wherein the shaft bearing portion 501 will be described below.

As shown in FIG. 4, the flexible arm 222 is formed by a part of the outer upper wall 22, wherein a slit 223 is cut out in the outer upper wall 22 around the lever rotating shaft 221 so that the flexible arm 222 is bendable in the Y-direction. The slit 223 includes a pair of rectilinear slits 223A, 223A and an arc-shaped slit 223B, wherein the arc-shaped slit 223B is continuous between the pair of rectilinear slits 223A, 223A. The pair of rectilinear slits 223A, 223A are disposed on both sides of the lever rotating shaft 221 in the Z-direction and opposed to each other in the Z-direction, and extend in the X-direction (forward and backward direction). According to the present embodiment, the pair of rectilinear slits 223A, 223A extend before a back end of the outer upper wall 22. The arc-shaped slit 223B is provided in an arc shape which is continuous with back ends of the rectilinear slits 223 and surrounds the lever rotating shaft 221.

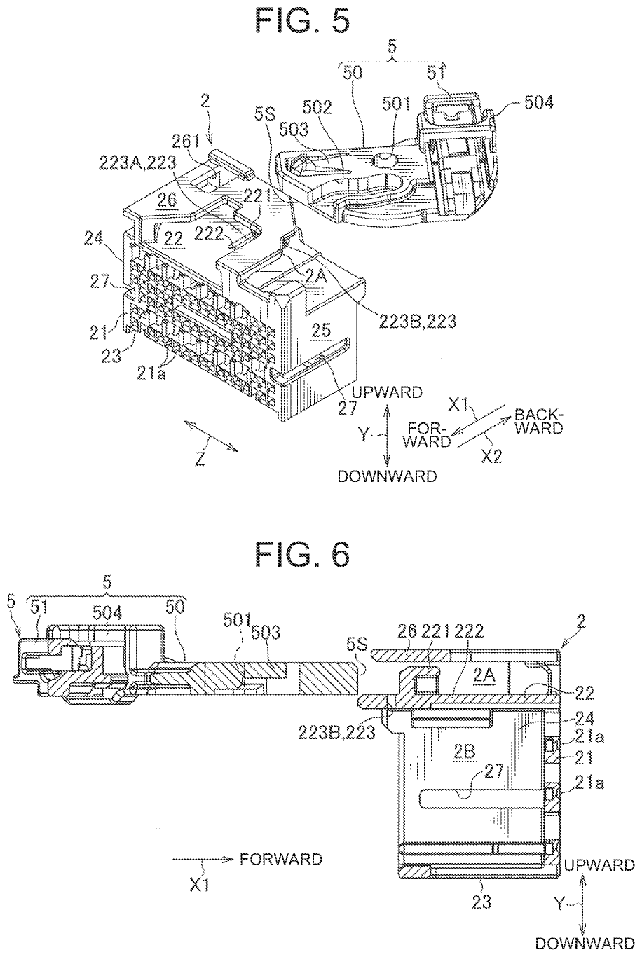

As shown in FIGS. 2 and 5, the outer shell wall 26 includes a lock receiving portion 261 for locking a temporary lock arm 503 of the lever main body 50 therein, wherein the temporary lock arm 261 will be described below. The lock receiving portion 261 is disposed at a corner on a back side of the outer shell wall 26 (on a side in the X2-direction) along a rotating direction of the lever main body 50 (clockwise as seen from above), wherein the lock receiving portion 261 is configured to lock the temporary lock arm 503 of the lever main body 50 therein when the lever main body 50 has reached a completely rotated position, as shown in FIG. 2, wherein the completely rotated position will be described below.

As shown in FIG. 2, each of outer surrounding walls 24 and 25 of the four outer surrounding walls 22, 23, 24 and 25 which are opposed to each other in the Z-direction includes a guide portion 27, wherein the guide portion 27 extends in the X-direction. Each of the guide portions 27, together with a guide receiving portion 36 in the inner housing 3 as described below, forms a guide unit 6 for guiding a rib on the partner connector when mating the connector 1 with the partner connector.

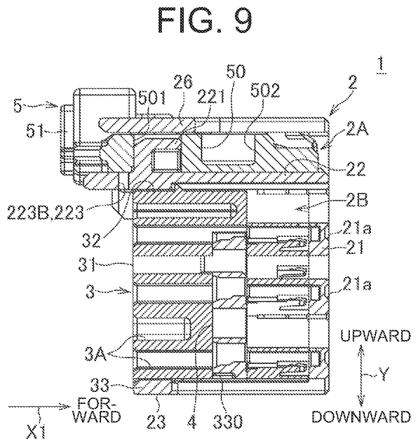

As shown in FIGS. 2 and 9, the inner housing 3 includes an inner wall section 31 along the ZY-plane, four inner surrounding walls 32, 33, 34 and 35, terminal accommodating chambers 3A, and a spacer accommodating chamber 3B (shown in FIG. 8), wherein the inner surrounding walls 32, 33, 34 and 35 are continuous with the inner wall section 31. Further, an inner lower wall 33 of the four inner surrounding walls 32, 33, 34 and 35 which is located above and opposed to the outer surrounding wall 23 includes an opening 330 formed therein as shown in FIG. 8, wherein the opening 330 is configured to insert a side spacer 4 therein. Surrounding walls 34 and 35 of the four inner surrounding walls 32, 33, 34 and 35 which are opposed to each other in the Z-direction include the guide receiving portions 36 as shown in FIG. 2, wherein the guide receiving portions 36, together with the respective guide portions 27 of the outer housing 2, form the guide units 6.

A plurality of terminal accommodating chambers 3A are aligned in an up-down direction (Y-direction) and the Z-direction, as shown in FIG. 8. Each of the terminal accommodating chambers 3A has a quadrilateral-tubular shape with an extending direction (axial direction of the tube) along the X-direction, and is configured to accommodate the respective terminals. The spacer accommodating chamber 3B is a part of the terminal accommodating chambers 3A and capable of accommodating the side spacer 4.

As shown in FIG. 8, the side spacer 4 is configured so as to be displaceable between a waiting position and an accommodating position, wherein in the waiting position, the side spacer 4 protrudes from the inner lower wall 33 while being inserted into the opening 330 in the inner housing 3, and in the accommodating position, the side spacer 4 has been pushed from the waiting position and accommodated in the spacer accommodating chamber 3B. When the side spacer 4 is in the waiting position, the terminals are allowed to be inserted into the terminal accommodating chambers 3A, while when the side spacer 4 is in the accommodating position, the side spacer 4 causes the terminals inserted in the terminal accommodating chambers 3A to be locked, whereby the terminals are held in the respective terminal accommodating chambers 3A.

As shown in FIGS. 2 and 5, the lever member 5 includes the lever main body 50 and a sliding element 51, wherein the lever main body 50 corresponds to a lever according to claims, wherein the sliding element 51 is slidably supported by the lever main body 50. The lever main body 50 is formed e.g. from resin in a plate shape. The lever main body 50 extends along the ZX-plane (the same direction in which outer upper wall 22 and outer shell wall 26 extend).

As shown in FIG. 5, the lever main body 50 includes the shaft bearing portion 501, a guide groove 502, the temporary lock arm 503 for locking the lock receiving portion 261 in the outer housing 2, and a slide supporting portion 504 for supporting the sliding element 51. The shaft bearing portion 501 is formed in a through-hole shape, and configured to allow a lever rotating shaft 221 of the outer housing 2 to be inserted through the shaft bearing portion 501. The lever main body 50 is configured to be (pivotably) supported so as to be rotatable relative to the outer housing 2 around the shaft bearing portion 501 and the lever rotating shaft 221 by inserting the lever rotating shaft 221 through the shaft bearing portion 501.

As shown in FIG. 5, the guide groove 502 is defined by forming a part of an inner surface of the lever main body 50 in a concave shape, and is configured to allow a guide protrusion of the partner connector to be inserted through the guide groove 502. The guide groove 502 is formed from a cam groove having a shape (trajectory) which brings the guide protrusion close to the shaft bearing portion 501 when the lever main body 50 is rotated.

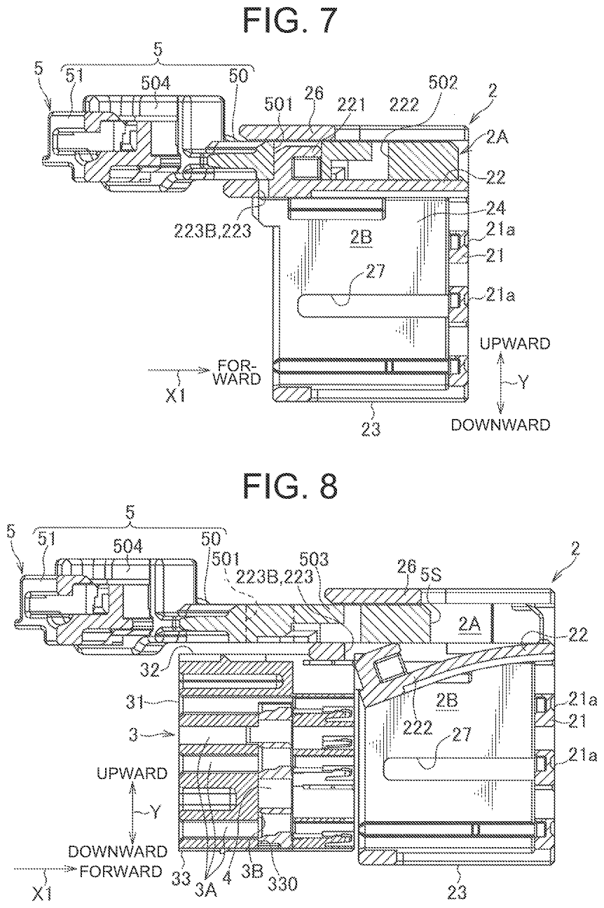

With the lever main body 50 as described above which is configured to be rotatable between an initial position (see FIG. 7) and a completely rotated position (see FIG. 9) while being pivotably supported by the outer housing 2, mating the connector 1 with the partner connector is accomplished by rotating the lever main body 50 from the initial position to the completely rotated position.

The sliding element 51 is supported by the slide supporting portion 504 so as to be slidable between a protruding position and a pushed-in position, wherein the sliding element protrudes backward (in the X2-direction) from the lever main body 50 in the protruding position, wherein the pushed-in position is located further forward (in the X1-direction) than the protruding position. Mating the connector 1 with the partner connector is ensured by the sliding element 51 which is slid from the protruding position to the pushed-in position when mating the connector 1 with the partner connector.

Next, a procedure for assembling the connector 1 will be described with reference to FIGS. 5 to 8. First, the side spacer 4 is inserted into the opening 330 in the inner housing 3 in advance, and positioned in the waiting position, to accommodate the terminals into the respective terminal accommodating chambers 3A in the inner housing 3. Thereafter, the side spacer 4 is pushed in to be positioned in the accommodating position. In this manner, the terminals are held in the respective terminal accommodating chamber 3A.

Next, an insertion forward end 5S (a portion of the lever main body 50 which is in the vicinity of an inlet of the guide groove 502) is brought close to and inserted into the lever mounting space 2A, as shown in FIGS. 5 and 6. By further inserting the insertion forward end 5S of the lever main body 50, the lever rotating shaft 221 comes into contact with the insertion forward end 5S, wherein the flexible arm 222 is bent, and the lever rotating shaft 221 is removed out of the lever mounting space 2A (into the housing accommodating space 2B) (see FIG. 8).

By further inserting the insertion forward end 5S of the lever main body 50, it crosses over the lever rotating shaft 221 so that the lever rotating shaft 221 is inserted through the shaft bearing portion 501 of the lever main body 50. Once the lever rotating shaft 221 has been inserted through the shaft bearing portion 501 of the lever main body 50, the flexible arm 222 is elastically returned to its original shape (natural state). In this manner, the rotation shaft section 221 is rotatably supported by the shaft bearing portion 501, as shown in FIG. 7, and the lever main body 50 is rotatably (pivotably) supported by the outer housing 2, wherein the lever main body 50 is positioned in the initial position.

Next, the inner housing 3 is brought close to the housing accommodating space 2B of the outer housing 2 and inserted into its front side (X1-direction). In this manner, the connector 1 is assembled.

Here, an operator recognizes the absence of a fault in the assembly process when the inner housing 3 is allowed to be inserted into the housing accommodating space 2B. However, as shown in FIG. 8, if the lever rotating shaft 221 is not inserted through the shaft bearing portion 501 of the lever main body 50 and the flexible arm 222 remains bent (incorrect condition), the insertion of the inner housing 3 into the housing accommodating space 2B is limited by the inner housing 3 coming into contact with the flexible arm 222 due to the flexible arm 222 having entered the housing accommodating space 2B. In this manner, the operator detects the incorrect condition (the presence of a fault in the assembly process) by the limitation of the insertion of the inner housing 3 into the housing accommodating space 2B.

Further, e.g. in the case where the inner housing 3 is brought close to the housing accommodating space 2B of the outer housing 2 and inserted into its front side (X1-direction) while the side spacer 4 is positioned in the waiting position, the insertion of the inner housing 3 into the housing accommodating space 2B is also limited by the side spacer 4 in contact with the outer surrounding wall 23 of the outer housing 2. In this manner, the operator can detect the presence of a fault in the assembly process by the limitation of the insertion of the inner housing 3 into the housing accommodating space 2B.

Then, the connector 1 will be mated with the partner connector by inserting the guide protrusion of the partner connector through the guide groove 502 of the connector 1 (shown in FIG. 5) and then by rotating the lever main body 50 to the completely rotated position as shown in FIG. 9.

The embodiment as described above provides that the outer housing 2 (housing) includes the outer upper wall 22 and the outer shell wall 26 (a pair of wall sections) opposed to each other in a rotation axis direction (arrow Y) of the lever main body 50 (lever), Wherein the outer upper wall 22 (one wall section) includes the rotation shaft section 221 protruding towards the outer shell wall 26 (another wall section), wherein the rotation shaft section 221 is provided in the flexible arm 222 which is cut out from the (outer upper wall 22), wherein it is configured so that in the natural state of the flexible arm 222, the lever main body 50 is pivotably supported by the rotation shaft section 221, wherein when the lever main body 50 comes into contact with the rotation shaft section 221, the flexible arm 222 is bent in a direction away from the outer shell wall 26 with interposition of the outer upper wall 22 (downward). With this configuration, when the lever main body 50 comes into contact with the rotation shaft section 221, the flexible arm 222 is bent to displace the rotation shaft section 221 downward, i.e. in the direction away from the outer shell wall 26 so that the rotation shaft section 221 is removed outside the outer upper wall 22 and the outer shell wall 26. This enables the lever main body 50 to be inserted between the outer upper wall 22 and the outer shell wall 26 without bending the walls 22, 26. Thus, it is possible to enable the operability for assembling the connector 1 to be improved.

Further, in the natural state of the flexible arm 222, the inner housing 3 is allowed to be inserted into the housing accommodating space 2B (insertion space), wherein in a bent state of the flexible arm 222, the flexible arm 222 enters the housing accommodating space 2B so that the inner housing 3 comes into contact with the flexible arm 222 to limit insertion of the inner housing 3 into the housing. With this configuration, it can be detected that the lever main body 50 (lever) is pivotably supported by the rotation shaft section 221 of the outer housing 2, by the fact that the inner housing 3 is allowed to be inserted into the housing accommodating space 2B. Moreover, by the fact that the insertion of the inner housing 3 into the housing is limited, the operator can detect that the lever rotating shaft 221 is not inserted into the shaft bearing portion 501 of the lever main body 50 and the flexible arm 222 remains bent (incorrect condition).

Although the best configuration, method etc. for implementing the present invention are disclosed in the above description, the present invention is not limited thereto. Namely, while the present invention is particularly shown and described mainly with regard to the specific embodiments, the above mentioned embodiments may be modified in various manners in shape, material characteristics, amount or other detailed features by those skilled in the art without departing from the scope of the technical idea and purpose of the present invention. Therefore, the description with limited shapes, material characteristics etc. according to the above disclosure is not limiting the present invention, but merely illustrative for easier understanding the present invention so that the description using names of the elements without a part or all of the limitations to their shapes, material characteristics etc. is also included in the present invention.

### REFERENCE SIGNS LIST

1 Connector
2 Outer housing (housing)
2B Housing accommodating space (insertion space)
3 Inner housing
22 Outer upper wall (one wall section)
26 Outer shell wall (another wall section)
221 Rotation shaft section (lever rotating shaft)
222 Flexible arm
50 Lever main body (lever)
Arrow Y Up-down direction (rotation axis direction of the lever)

What is claimed is:

1. A connector comprising:
a housing; and
a plate-shaped lever which is pivotably supported by the housing and rotatable,
wherein the housing includes a pair of wall sections opposed to each other in a rotation axis direction of the lever,
wherein one wall section of the pair of wall sections includes a rotation shaft section protruding towards another wall section of the pair of wall sections,
wherein the rotation shaft section is provided in a flexible arm which is cut out from the one wall section, and
wherein it is configured so that in a natural state of the flexible arm, the lever is pivotably supported by the rotation shaft section, wherein when the lever which is not mounted is inserted between the pair of wall sections and comes into contact with the rotation shaft section, the flexible arm is bent in a direction away from the another wall section with interposition of the one wall section.

2. The connector according to claim 1, further comprising:
an inner housing configured to be inserted into the housing,
wherein the housing has an insertion space for inserting the inner housing therein,
wherein in the natural state of the flexible arm, the inner housing is allowed to be inserted into the housing, and
wherein in a bent state of the flexible arm, the flexible arm enters the insertion space so that the inner housing comes into contact with the flexible arm to limit insertion of the inner housing into the housing.
